(19) United States
(12) Patent Application Publication
(10) Pub. No.: US 2022/0322672 A1
(43) Pub. Date: Oct. 13, 2022

(54) HYDROGEN PEROXIDE DISINFECTANT COMPOSITION

(71) Applicant: Metrex Research LLC, Orange, CA (US)

(72) Inventors: Xiang Gao, Orange, CA (US); James Liang-Hiong Chia, Irvine, CA (US); Alexander L. Wollenberg, Brea, CA (US); Ryan Lakey, Orange, CA (US); Vincent Chao, Orange, CA (US); Ho Dinh, Orange, CA (US)

(21) Appl. No.: 17/228,826

(22) Filed: Apr. 13, 2021

(51) Int. Cl. A01N 59/00; A01N 25/30; A01N 25/34

(52) U.S. Cl. CPC A01N 59/00; A01N 25/30; A01N 25/34

(57) ABSTRACT

A disinfectant composition is provided that has been found to be particularly effective in inactivating and/or destroying microorganisms. The disinfectant composition can include hydrogen peroxide, an organic solvent, at least one fatty acid having 6 to 9 carbon atoms or an aromatic carboxylic acid, at least two surfactants with the first surfactant being an amphoteric surfactant and the second surfactant being a nonionic surfactant, and an acidic pH adjuster. The disinfectant composition has been found to be particularly effective against microorganisms when the organic solvent and the fatty acid or aromatic carboxylic acid are present in a ratio from about 3:1 to about 30:1, the fatty acid or aromatic carboxylic acid and the amphoteric surfactant are present in a ratio from about 0.1:1 to about 3:1, and the organic solvent and the amphoteric surfactant are present in a ratio from about 1:1 to about 30:1.

### TECHNICAL FIELD

The present invention relates to disinfectant compositions and, more specifically, to a hydrogen peroxide disinfectant composition such as for disinfecting surfaces.

### BACKGROUND

Microbial infection is a significant healthcare problem. Indeed, by some estimates, the incidence of healthcare-associated infection (HAI) is around 1 out of each 31 patients. Not surprisingly, treatment clinics and hospitals contain many surfaces that tend to harbor the microbes responsible for infection and must be thoroughly sanitized and disinfected often.

Pathogenic microbes, in particular, present a high risk of infectious disease that can cause a myriad of symptoms or forms of discomfort. In many cases, once a person has an infection, the infection can spread to others by either airborne droplet transmission or shared surface transmission, for example. People who touch shared surfaces can contract pathogens that another person has left behind. Thus, the first line of defense against microbial infection is the treatment of such surfaces with disinfectants. Various disinfectant solutions have been insufficiently effective at combating pathogenic microbes. For example, quaternary ammonium compounds (QACs) are considered active ingredients with the capability of deactivating most bacteria and virus species, whilst low concentration of QACs is not considered powerful enough to disinfect most hard-to-kill pathogens such as mycobacteria tuberculosis (TB) and bacterial spores. Concerning aldehydes and peracetic acid, although highly effective in disinfecting and sterilizing pathogens on critical and semi-critical medical devices, the usage of these chemicals is limited by the severe occupational safety and environmental concerns.

In view thereof, there is a need for an improved disinfectant composition, which can exhibit desirable activity against pathogenic microbes and can have a desirable toxicological profile.

### SUMMARY

The present invention is directed to a hydrogen peroxide disinfectant composition such as for disinfecting surfaces.

In accordance with an embodiment of the invention, a disinfectant composition is provided, which can include hydrogen peroxide, an organic solvent (e.g. benzyl alcohol), at least one fatty acid having 6 to 9 carbon atoms or an aromatic carboxylic acid, at least two surfactants with the first surfactant being an amphoteric surfactant and the second surfactant being a nonionic surfactant, and an acidic pH adjuster.

In accordance with another embodiment of the invention, a disinfectant composition is provided, which can include hydrogen peroxide, an organic solvent in an amount from about 0.9 wt % to 4 wt % of the composition, one of a fatty acid selected from the group consisting of hexanoic acid, heptanoic acid, octanoic acid, and nonanoic acid, or an aromatic carboxylic acid selected from benzoic acid, salicylic acid, or 2-fuoric acid, a first surfactant comprising an amine oxide, a second surfactant comprising an alcohol ethoxylate, and an acidic pH adjuster, wherein the organic solvent and the fatty acid or aromatic carboxylic acid are present in a ratio from about 10:1 to about 30:1, the fatty acid or aromatic carboxylic acid and first surfactant are present in a ratio from about 0.1:1 to about 3:1, and the organic solvent and first surfactant are present in a ratio from about 1:1 to about 30:1.

In accordance with another embodiment of the invention, a disinfectant composition is provided, which can include hydrogen peroxide, benzyl alcohol in an amount from 2 wt % to 4 wt % of the disinfectant composition, one of a fatty acid selected from the group consisting of hexanoic acid, heptanoic acid, octanoic acid, and nonanoic acid or an aromatic carboxylic acid selected from benzoic acid, 2-furoic acid, or salicylic acid, an amphoteric surfactant, a nonionic surfactant, an acidic pH adjuster, and water, wherein the benzyl alcohol and the fatty acid or aromatic carboxylic acid are present in a ratio from about 3:1 to about 30:1, the fatty acid or aromatic carboxylic acid and the amphoteric surfactant are present in a ratio from about 0.1:1 to about 3:1, and the benzyl alcohol and the amphoteric surfactant are present in a ratio from about 1:1 to about 30:1, and wherein the composition is free from any peracids.

### DETAILED DESCRIPTION

All concentrations herein are based on the total weight of the specified disinfectant composition, unless stated otherwise. Weight percent, weight %, wt. %, wt %, percent by weight, and % by weight are synonyms that refer to the concentration of a substance as the weight of that substance, divided by the weight of the composition, and multiplied by 100. In addition, all ranges of values include the end points of the ranges.

In accordance with embodiments of the present invention, a disinfectant composition is provided that has been found to be particularly effective for inactivating and/or destroying pathogens, including bacteria, viruses, fungi (e.g., trichophyton), and other microorganisms, when those pathogens are subjected to the disinfectant composition for an effective period of time. For example, the disinfectant composition is understood to be particularly effective at inactivating and/or destroying pathogens selected from Trichophyton mentagrophytes, Mycobacterium bovis (a surrogate for TB), Staphylococcus aureus, Pseudomonas aeruginosa, Salmonella enterica, Candida albicans, Candida auris, Feline calicivirus, and the like. In one example, data from suspension time-kill tests show that the disinfectant composition can be effective at destroying Trichophyton mentagrophytes. Furthermore, data from nonporous surface wiping time-kill tests have shown the disinfectant composition can be effective at destroying pathogens selected from Mycobacterium bovis (a surrogate for TB), Staphylococcus aureus, Pseudomonas aeruginosa, Salmonella enterica, Candida albicans, Candida auris, Feline calicivirus, and the like.

In one example, the disinfectant composition, which is discussed in greater detail below, can include hydrogen peroxide, an organic solvent (e.g., benzyl alcohol), at least one fatty acid having 6 to 9 carbon atoms or an aromatic carboxylic acid, at least two surfactants with the first surfactant being an amphoteric surfactant and the second surfactant being a nonionic surfactant, and an acidic pH adjuster. The disinfectant composition has been found to be particularly effective against pathogens when the organic solvent (e.g., benzyl alcohol), the fatty acid and/or aromatic carboxylic acid, and the amphoteric surfactant are present, for example, in particular ratios. Particularly desirable mass ratios of the organic solvent to fatty acid and/or aromatic carboxylic acid include a mass ratio from 3:1 to 30:1, by percent weight of the disinfectant composition. Particularly desirable mass ratios of the organic solvent to the amphoteric surfactant include a mass ratio from 1:1 to 30:1, by percent weight of the disinfectant composition. Particularly desirable mass ratios of the fatty acid or aromatic carboxylic acid to amphoteric surfactant include a mass ratio from 0.1:1 to 3:1, by percent weight of the disinfectant composition. The disinfectant composition can be in liquid form and may be used as a soak or spray to provide a disinfectant soak or spray, such as a ready to use spray, or be provided on a substrate, such as a wipe, by means and methods known in the art, to provide a disinfectant wipe such as for sanitizing and disinfecting surfaces.

Concerning now the hydrogen peroxide, the hydrogen peroxide in the disinfectant composition can be present in an amount from 0.1 wt % to 8 wt % of the disinfectant composition. In another example, the hydrogen peroxide can be present in an amount from 0.1 wt % to 2 wt %. In another example, the hydrogen peroxide can be present in an amount from 0.5 wt % to 1.5 wt %. In yet another example, the hydrogen peroxide can be present in an amount from 0.5 wt % to 0.9 wt %.

The organic solvent in the disinfectant composition can include benzyl alcohol, phenethyl alcohol, phenoxy glycol, and the like and be present in an amount from 0.9 wt % to 4 wt % of the disinfectant composition. In another example, the organic solvent can be present in an amount from 1 wt % to 4 wt % of the disinfectant composition. In another example, the organic solvent can be present in an amount from 1 wt % to 3 wt % or from 2 wt % to 4 wt % of the disinfectant composition. In another example, the organic solvent can be present as 3 wt % of the disinfectant composition.

The fatty acid in the disinfectant composition can include 6 to 9 carbon atoms. In one example, the fatty acid can be a saturated, unbranched fatty acid having 6 to 9 carbon atoms. For example, the fatty acid can include hexanoic, heptanoic, octanoic, nonanoic acid, or combinations thereof. In another example, the fatty acid can be an unsaturated, unbranched fatty acid having 6 to 9 carbon atoms. The fatty acid can be present in an amount from 0.01 wt % to 10 wt % of the disinfectant composition. In another example, the fatty acid can be present in an amount from 0.1 wt % to 5 wt %. In another example, the fatty acid can be present in an amount from 0.1 wt % to 1 wt %. In yet another example, the fatty acid can be present in an amount from 0.1 wt % to 0.6 wt %. In another example, the fatty acid can be present in an amount from 0.1 wt % to 0.4 wt %. In another example, the fatty acid can be present in an amount from 0.1 wt % to 0.3 wt %. In yet another example, the fatty acid can be present in an amount of 0.3 wt %.

The aromatic carboxylic acid in the disinfectant composition can include a heterocyclic carboxylic acid with an aromatic ring (e.g., a five-membered aromatic ring), such as 2-furoic acid and the like, a six-carbon aromatic carboxylic acid, such as benzoic acid, salicylic acid, and the like, or combinations thereof. Moreover, the aromatic carboxylic acid may be mixed with the fatty acid described above such that the disinfectant composition may include both the fatty acid and the aromatic carboxylic acid. The aromatic carboxylic acid can be present in an amount from 0.01 wt % to 10 wt % of the disinfectant composition. In another example, the aromatic carboxylic acid can be present in an amount from 0.1 wt % to 5 wt %. In another example, the aromatic carboxylic acid can be present in an amount from 0.1 wt % to 1 wt %. In yet another example, the aromatic carboxylic acid can be present in an amount from 0.1 wt % to 0.6 wt %. In another example, the aromatic carboxylic acid can be present in an amount from 0.1 wt % to 0.4 wt %. In another example, the aromatic carboxylic acid can be present in an amount from 0.1 wt % to 0.3 wt %. In yet another example, the aromatic carboxylic acid can be present in an amount of 0.3 wt %.

The amphoteric surfactant in the disinfectant composition can include an amine oxide, such as an alkyl amine oxide. In one example, the alkyl amine oxide can include an alkyl dimethyl amine oxide, such as lauramine oxide, myristal amine oxide, decyl dimethyl amine oxide, cocoamine oxide, octyl dimethyl amine oxide and the like. In one example, the amphoteric surfactant is a lauramine oxide, which can be included in solution and have the tradename Ammonyx® LO manufactured by Stepan Company of Northfield, Ill., USA. Ammonyx® LO includes an amphoteric surfactant having the following structure:

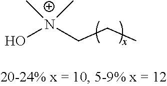

The %'s are based on the weight of amine oxide over the total weight of solution. Accordingly, the Ammonyx® LO solution has at least two amphoteric surfactants with one having the above structure where x=10 and a second having the above structure where x=12.

In another example, the amphoteric surfactant can include an octyl dimethyl amine oxide, which can be included in solution and have the tradename Barlox™ 8S manufactured by Lonza Group of Basel, Switzerland. In another example, the amphoteric surfactant is a decyl dimethyl amine oxide, which can be included in solution and have the tradename Barlox™ 10S manufactured by Lonza Group of Basel, Switzerland. In another example, the amphoteric surfactant is a cocoamine oxide, which can be included in solution and have the tradename Barlox™ 12 manufactured by Lonza Group of Basel, Switzerland. In yet another example, the amphoteric surfactant is a myristal amine oxide, which can be included in solution and have the tradename Barlox™ 14 manufactured by Lonza Group of Basel, Switzerland. The amphoteric surfactant can be present in the disinfectant composition in an amount from 0.1 wt % to 2 wt % of the disinfectant composition. In another example, the amphoteric surfactant can be present in an amount from 0.1 wt % to 1.5 wt % of the disinfectant composition. In another example, the amphoteric surfactant can be present in an amount from 0.1 wt % 1 wt % of the disinfectant composition. Each of Barlox™ 8S, Barlox™ 10S, Barlox™ 12, and Barlox™ 14 can be defined by the following formula with each surfactant identified according to the criteria set out in the table below:

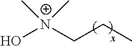

| Surfactant | Composition |
|---|---|
| Barlox 8S | 40-42% x = 6 |
| Barlox 10S | 30-32% x = 8 |
| Barlox 12 | 20-22% x = 10, 7-9% x = 12, 1-3% x = 14 |
| Barlox 14 | 11-13% x = 10, 14-16% x = 12, 2-4% x = 14 |

* % are based on the weight of amine oxide over the total weight of solution.
Accordingly, the Barlox 12 and Barlox 14 solutions, specifically have at
least three amphoteric surfactants with one having the above structure
where x = 10, a second having the above structure where x = 12, and a third
having the above structure where x = 14, in different amounts.

The nonionic surfactant in the disinfectant composition can include an ethoxylated alcohol. The ethoxylated alcohol may have between 1 and 13 moles of ethoxylation per mole of ethoxylated alcohol. Furthermore, the ethoxylated alcohol may have a straight chain, branched, or cyclic alkyl carbon chain including between 1 and 15 carbon atoms. The alkyl carbon chain may be saturated or unsaturated. In one example, the nonionic surfactant is an ethoxylated alcohol, which can have the tradename Tomadol® 900 manufactured by Evonik Industries of Essen, Germany. In another example, the nonionic surfactant is an ethoxylated alcohol, which can have the tradename Plurafac™ RA manufactured by Pressure Vessel Services, Inc. of Detroit, Mich., USA. In another example, the nonionic surfactant is an ethoxylated alcohol, which solution having the tradename NEODOL™ N91 or an ethoxylated alcohol solution having the tradename NEODOL™ N1, each of which are manufactured by Royal Dutch Shell headquartered in Haagse Hout, The Hague. Tomadol® 900, Plurafac™, NEODOL™ N91, and NEODOL™ N1 each include an ethoxylated alcohol having the following chemical structure with each surfactant identified according to the criteria set out in the table below:

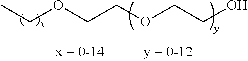

| Surfactant | Composition |
|---|---|
| Tomadol ® | x ~9, Y ~6, M.W. ~460 |
| Plurafac ™ RA | x ~10-16, Y ~unknown*, M.W. ~460 |
| NEODOL ™ N91 | x ~9, Y ~7, M.W. ~510 |

*The exact specification can be found by contacting manufacturers.

The nonionic surfactant may be present in the disinfectant composition in an amount from 0.01 wt % to 0.6 wt % of the disinfectant composition. In another example, the nonionic surfactant may be present in an amount from 0.02 wt % to 0.5 wt %. In another example, the nonionic surfactant may be present in an amount from 0.05 wt % to 0.3 wt %.

The acidic pH adjuster in the disinfectant composition can include any suitable acid for adjusting the pH to a desired acidic pH. In one example, the acidic pH adjuster can include phosphoric acid, sulfuric acid, hydrochloric acid, methanesulfonic acid, and the like. In one example, the pH adjuster can be added to adjust the pH of the disinfectant composition to be from about 0.6 to about 7. In another example, the pH adjuster can be added to adjust the pH of the disinfectant composition to be from about 1 to about 4. In another example, the pH adjuster can be added to adjust the pH of the disinfectant composition to be from about 1 to about 3. In another example, the pH adjuster can be added to adjust the pH of the disinfectant composition to be from about 1.8 to about 2.8. The pH adjuster can be present in the disinfectant composition in an amount from 0.1 wt % to 2 wt % of the disinfectant composition. In another example, the pH adjuster can be present in the disinfectant composition in an amount from 0.1 wt % to 1 wt %. In another example, the pH adjuster can be present in the disinfectant composition in an amount from 0.2 wt % to 0.8 wt %. In another example, the pH adjuster can be present in the disinfectant composition in an amount from 0.3 wt % to 0.6 wt %. It should be understood that these amounts may be exceeded dependent, in large part, upon the concentration of the acidic pH adjuster used.

The remainder of the disinfectant composition can be water such that all components in the disinfectant composition add up to 100 wt %. In one example, the water in the disinfectant composition can be about 95 wt % of the disinfectant composition. In one example, the water in the disinfectant composition can be about 90 wt % of the disinfectant composition.

In one embodiment, the disinfectant composition does not include any peracids insofar as it is understood not to form any detectable peracids, for example. In one example, the disinfectant composition can be free from any peracids or any detectable peracids.

The disinfectant composition has been found to be particularly effective against pathogens when the organic solvent (e.g., benzyl alcohol), the fatty acid or aromatic carboxylic acid, and the amphoteric surfactant are present, for example, in particular ratios. Particularly desirable mass ratios of the organic solvent to fatty acid or aromatic carboxylic acid include a mass ratio from 3:1 to 30:1, by percent weight of the disinfectant composition. In another example, the mass ratio can be from 5:1 to 15:1, by percent weight of the disinfectant composition. In another example, the mass ratio can be about 10:1, by percent weight of the disinfectant composition. Particularly desirable mass ratios of the organic solvent to the amphoteric surfactant include a mass ratio from 1:1 to 60:1, by percent weight of the disinfectant composition. In another example, the mass ratio can be from 1:1 to 45:1, by percent weight of the disinfectant composition. In another example, the mass ratio can be from 1:1 to 30:1, by percent weight of the disinfectant composition. In yet another example, the mass ratio can be from 1:1 to 25:1, by percent weight of the disinfectant composition. Particularly desirable mass ratios of the fatty acid or aromatic carboxylic acid to amphoteric surfactant include a mass ratio from 0.1:1 to 3:1, by percent weight of the infectant composition. In another example, the mass ratio can be from 0.5:1 to 2:1, by percent weight of the disinfectant composition. In another example, the mass ratio can be about 1:1, by percent weight of the disinfectant composition.

The disinfectant composition can be in liquid form and may be used as a soak or spray to provide a disinfectant soak or spray, such as a ready to use spray, or be provided on a substrate, such as a wipe, by means and methods known in the art, to provide a disinfectant wipe such as for sanitizing and disinfecting surfaces. Suitable substrates for the disinfectant wipes can include, for example, woven and non-woven webs, fabrics, foams, sponges, pads, and similar material constructs capable of absorbing and/or adsorbing the liquid disinfectant composition. In one example, the substrate or carrier can be in sheet form, that is, in a form in which the cross-sectional thickness dimension of the absorbent carrier is proportionally smaller than either its approximate width or length dimension in order to provide at least one surface whose surface area is sized appropriately with respect to the intended surface to be treated with the disinfectant article, e.g., disinfectant wipe. The carrier may be formed into individual sheets or wipes, or a continuous sheet, preferably with some separation means provided, such as partial tears or perforations across at least one dimension of the sheet, such that the sheet may be subdivided prior to use to a suitable size for the particular need.

Suitable substrates are generally selected from natural and synthetic materials, and can include suitable substrates that are bleach stable, in that they undergo no significant degradation or no significant chemical or physical change in structure, properties, or form, by contact with the components of the disinfectant composition. The substrate may include a single polymer or a mixture of two or more polymers. Suitable materials generally include synthetic polymer substrates, such as polyethylene terephthalate (PET), polyester (PE), high density polyethylene (HDPE), polyvinyl chloride (PVC), chlorinated polyvinylidene chloride (CPVC), polyacrylamide (ACAM), polystyrene (PS), polypropylene (PP), polycarbonate (PC), polyaryletherketone (PAEK), poly(cyclohexylene dimethylene cyclohexanedicarboxylate) (PCCE), poly(cyclohexylene dimethylene terephthalate) (PCTA), poly(cyclohexylene dimethylene terephthalate) glycol (PCTG), polyetherimide (PEI), polyethersulfone (PES), poly(ethylene terephthalate) glycol (PETG), polyketone (PK), poly(oxymethylene); polyformaldehyde (POMF), poly(phenylene ether) (PPE), poly(phenylene sulfide) (PPS), poly(phenylene sulfone) (PPSU), syndiotactic polystyrene (syn-PS), polysulfone (PSU), polytetrafluoroethylene (PTFE), polyurethane (PUR), poly(vinylidene fluoride) (PVDF), polyamide thermoplastic elastomer (TPA), polybutylene (PB), polybutylene terephthalate (PBT), polypropylene terephthalate (PPT), polyethylene naphthalate (PEN), polyhydroxyalkanoate (PHA), poly(methyl)methacrylate (PMMA) and polytrimethylene terephthalate (PTT).

Additionally, the material of the substrate may include copolymers made from the following monomers: acrylonitrile-butadiene-styrene (ABS), acrylonitrile-styrene-acrylate (ASA), ethylene-propylene (E/P), ethylene-vinyl acetate (EVAC), methyl methacrylate-acrylonitrile-butadiene-styrene (MABS), methacrylate-butadiene-styrene (MB S), melamine-formaldehyde (MF), melamine-phenol-formaldehyde (MPF), phenol-formaldehyde (PF), styrene-butadiene (SB), styrene-maleic anhydride (SMAH), copolyester thermoplastic elastomer (TPC), olefinic thermoplastic elastomer (TPO), styrenic thermoplastic elastomer (TPS), urethane thermoplastic elastomer (TPU), thermoplastic rubber vulcanisate (TPV), copolymer resins of styrene and acrylonitrile (SAN), styrene butadiene copolymer (SBC) and vinyl acetate-ethylene copolymer (VAE), and regenerated cellulose fiber (Rayon/viscose).

The disinfectant composition described herein is understood to be effective at inactivating and/or destroying pathogens, including bacteria, viruses, fungi (e.g., trichophyton), and/or other microorganisms, when the pathogens come into contact with the disinfectant composition for an effective period of time. The following non-limiting Examples are intended to help illustrate the efficacy of the disinfectant compositions of the present invention

### EXAMPLES—Efficacy Testing

Testing pathogen: Trichophyton mentagrophytes, 1 minute contact time

Testing method: Suspension test (quantitative)

Suspension Test Description:

Prior to use in testing, the initial population of the fungal suspension was determined, and the plates incubated. In a suspension test, a certain amount of the fungal suspension is transferred to a sterile tube containing the test material and mixed thoroughly. The fungal suspension is exposed to the test material for 1 minute, timed using a calibrated minute/second timer. After the exposure time has elapsed, a certain amount of liquid is transferred from the tube containing product/fungal suspension to a separate sterile test tube containing neutralization solution and mixed thoroughly. A series of dilutions (e.g., 10-2, 10-3, and 10-4) of the fungal suspension is prepared. From the final dilutions of the product/neutralizer/fungal suspension, a certain amount of liquid is spread-plated producing final plated dilutions. The plates are incubated. Following incubation, the colonies on the plates are counted and compared against the original culture size. No interfering substances are added in this phase.

Various disinfectant composition samples were tested for efficacy against Trichophyton mentagrophytes and certain parameters adjusted to measure each parameter's efficacy effects. As a result, certain synergies were noticed and certain effective amounts, ratios, and components identified.

In the Tables below and with respect to the weight percentages of the various surfactants, for example, Ammonyx® LO and Tomadol® 900, the weight percentages shown indicate the amount of the amphoteric surfactant or nonionic surfactant, respectively, in the tested disinfectant composition, rather than the weight percentage of each surfactant solution therein. Otherwise, the percentages of the various components in the Tables below are the weight percentage(s) of that component within the disinfectant composition.

As shown in Table 1 below, samples of disinfectant compositions, which included increasing levels of octanoic acid, were tested and the efficacy results considered and compared.

TABLE 1
Concentration of Octanoic Acid

| | Hydrogen | Benzyl | Octanoic | Ammonyx | Tomadol | Phosphoric | Efficacy Log |
|---|---|---|---|---|---|---|---|
| Sample ID | Peroxide | Alcohol | Acid | LO | 900 | Acid | reduction/control |
| Comparative 1 | 0.9% | 3.0% | 0.0% | 0.3% | 0.3% | 1.0% | 1.01/6.46 |
| Example 1 | 0.9% | 3.0% | 0.1% | 0.3% | 0.3% | 1.0% | 2.58/6.46 |
| Example 2 | 0.9% | 3.0% | 0.3% | 0.3% | 0.3% | 1.0% | >5.60/6.60 |

The results in Table 1 show that there is a desirable increase in efficacy of the disinfectant composition with an increase in weight percentage of fatty acid, e.g., octanoic acid, in the disinfectant composition. It is also show that the efficacy of the disinfectant composition increases as the relative ratio of the fatty acid to the amphoteric surfactant nears a 1:1 ratio and as the fatty acid to the benzyl alcohol nears a 1:10 ratio.

With further testing, comparative disinfectant compositions including fatty acids with carbon chain lengths less than or equal to 5 and carbon chain lengths greater than or equal to 10 were found to be less effective than disinfectant compositions including fatty acids having carbon chain lengths from 6 to 9. Table 2 below includes the data supporting this observation.

TABLE 2
Fatty Acid/fatty acid chain length

| | Hydrogen | Benzyl | Fatty Acid, | Ammonyx | Tomadol | Phosphoric | Efficacy Log |
|---|---|---|---|---|---|---|---|
| Sample ID | Peroxide | Alcohol | 0.3% | LO | 900 | Acid | reduction/control |
| Comparative 1 | 0.9% | 3.0% | Propanoic Acid | 0.3% | 0.3% | 0.5% | 3.09/6.30 |
| Comparative 2 | 0.9% | 3.0% | Butanoic acid | 0.3% | 0.3% | 0.5% | 1.81/6.76 |
| Comparative 3 | 0.9% | 3.0% | Pentanoic Acid | 0.3% | 0.3% | 1.0% | 3.45/6.44 |
| Example 1 | 0.9% | 3.0% | Hexanoic Acid | 0.3% | 0.3% | 1.0% | >5.44/6.44 |
| Example 2 | 0.9% | 3.0% | Heptanoic Acid | 0.3% | 0.3% | 1.0% | >5.44/6.44 |
| Example 3 | 0.9% | 3.0% | Octanoic Acid | 0.3% | 0.3% | 1.0% | >5.60/6.60 |
| Example 4 | 0.9% | 3.0% | Nonanoic Acid | 0.3% | 0.3% | 1.0% | >5.46/6.46 |
| Comparative 4 | 0.9% | 3.0% | Decanoic Acid | 0.3% | 0.3% | 1.0% | 2.41/6.46 |
| Comparative 5 | 0.9% | 3.0% | Dodecanoic Acid | 0.3% | 0.3% | 1.0% | 1.21/6.46 |
| Comparative 6 | 0.9% | 3.0% | Tetradecanoic Acid | 0.3% | 0.3% | 1.0% | 1.12/6.60 |

The results in Table 2 show that the disinfectant compositions having fatty acids with 6 to 9 carbon chain lengths were considerably more effective than those below 6 and above 9 carbon chain lengths. Indeed, clearly shown is a spike in efficacy for those disinfecting compositions including hexanoic acid, heptanoic acid, octanoic acid, and nonanoic acid.

Disinfecting compositions having varying weight percentages of benzyl alcohol were tested and their efficacies compared. Table 3 below shows the results of these tests.

TABLE 3
Concentration of Benzyl Alcohol

| | Hydrogen | Benzyl | Octanoic | Ammonyx | Tomadol | Phosphoric | Efficacy Log |
|---|---|---|---|---|---|---|---|
| Sample ID | Peroxide | Alcohol | Acid | LO | 900 | Acid | reduction/control |
| Comparative 1 | 0.9% | 0.0% | 0.3% | 0.3% | 0.3% | 1.0% | 0.64/6.46 |
| Example 1 | 0.9% | 1.0% | 0.3% | 0.3% | 0.3% | 1.0% | 1.81/6.44 |
| Example 2 | 0.9% | 2.0% | 0.3% | 0.3% | 0.3% | 1.0% | >5.44/6.44 |
| Example 3 | 0.9% | 3.0% | 0.3% | 0.3% | 0.3% | 1.0% | >5.60/6.60 |

The results in Table 3 above show that there is a desirable increase in efficacy of the disinfectant composition with an increase in weight percentage of the benzyl alcohol in the disinfectant composition. That is, the efficacy of the disinfectant composition increases as the relative ratio of benzyl alcohol to the fatty acid and the ratio of benzyl alcohol to the first surfactant increases.

Disinfecting compositions having varying weight percentages of the first surfactant were tested and their efficacies compared. Table 4 below shows the results of these tests.

TABLE 4
Concentration of first surfactant

| | Hydrogen | Benzyl | Octanoic | Ammonyx | Tomadol | Phosphoric | Efficacy Log |
|---|---|---|---|---|---|---|---|
| Sample ID | Peroxide | Alcohol | Acid | LO | 900 | Acid | reduction/control |
| Comparative 1 | 0.9% | 3.0% | 0.3% | 0.0% | 0.3% | 1.0% | 4.31/6.46 |
| Example 1 | 0.9% | 3.0% | 0.3% | 0.3% | 0.3% | 1.0% | >5.60/6.60 |
| Example 2 | 0.9% | 3.0% | 0.3% | 1.0% | 0.3% | 1.0% | 3.00/6.44 |

The results of Table 4 show that there is a desirable amount of the first surfactant or a desirable ratio, for example, of the first surfactant to benzyl alcohol and/or desirable ratio of the first surfactant to the fatty acid that can produce a disinfectant composition with a desired or maximum efficacy. That is, the efficacy of the disinfectant composition increases as the relative ratio of first surfactant to benzyl alcohol is about 10:1 and the relative ratio of first surfactant to fatty acid is about 1:1. The relationship of both of these ratios is not consistently in the same direction. That is to say, an increase in a ratio of first surfactant to fatty acid or an increase of first surfactant to benzyl alcohol does not necessarily result in an increase in efficacy. Efficacy of the disinfectant composition was shown to be particularly high or desirable when the mass ratios of the organic solvent to fatty acid or aromatic carboxylic acid include a mass ratio from about 3:1 to 30:1, by percent weight of the disinfectant composition. Particularly desirable mass ratios of the organic solvent to the amphoteric surfactant include a mass ratio from 1:1 to 30:1, by percent weight of the disinfectant composition. Particularly desirable mass ratios of the fatty acid or aromatic carboxylic acid to amphoteric surfactant include a mass ratio from 0.1:1 to 3:1, by percent weight of the infectant composition.

Disinfecting compositions having varying weight percentages of the second surfactant were tested and their efficacies compared. Table 5 below shows the results of these tests.

TABLE 5
Concentration of second surfactant

| | Hydrogen | Benzyl | Octanoic | Ammonyx | Tomadol | Phosphoric | Efficacy Log |
|---|---|---|---|---|---|---|---|
| Sample ID | Peroxide | Alcohol | Acid | LO | 900 | Acid | reduction/control |
| Comparative 1 | 0.9% | 3.0% | 0.3% | 0.3% | 0.0% | 1.0% | >5.46/6.46 |
| Example 1 | 0.9% | 3.0% | 0.3% | 0.3% | 0.3% | 1.0% | >5.60/6.60 |
| Example 2 | 0.9% | 3.0% | 0.3% | 0.3% | 1.0% | 1.0% | >5.46/6.46 |

The results of Table 5 show, for example, that there is a similar efficacy with all three compositions tested.

Disinfecting compositions having varying weight percentages of the pH adjuster were tested and their efficacies compared. Table 6 below shows the results of these tests.

TABLE 6
Concentration of pH Adjuster

| | Hydrogen | Benzyl | Nonanoic | Ammonyx | Tomadol | Phosphoric | | Efficacy Log |
|---|---|---|---|---|---|---|---|---|
| Sample ID | Peroxide | Alcohol | Acid | LO | 900 | Acid | pH | reduction/control |
| Comparative 1 | 0.5% | 2.0% | 0.3% | 0.2% | 0.1% | 0.0% | 4.47 | 1.29/7.08 |
| Example 1 | 0.5% | 2.0% | 0.3% | 0.2% | 0.1% | 0.1% | 2.79 | 2.58/7.08 |
| Example 2 | 0.5% | 2.0% | 0.3% | 0.2% | 0.1% | 0.5% | 2.11 | 3.65/7.08 |

The results in Table 6 above show that there is a gradual increase in efficacy of the disinfectant composition with an increase in weight percentage of the phosphoric acid in the disinfectant composition.

Disinfecting compositions having varying weight percentages of the organic solvent were tested and their efficacies compared. Table 7 below shows the results of these tests.

TABLE 7
Organic Solvents

| | Hydrogen | Organic | Nonanoic | Ammonyx | Tomadol | Phosphoric | Efficacy Log |
|---|---|---|---|---|---|---|---|
| Sample ID | Peroxide | Solvent | Acid | LO | 900 | Acid | reduction/control |
| Example 1 | 0.9% | Benzyl | 0.3% | 0.3% | 0.3% | 0.5% | >5.60/6.60 |
| | | Alcohol, 3% | | | | | |
| Comparative 1 | 0.9% | Benzyl | 0.3% | 0.3% | 0.3% | 0.5% | 2.24/6.30 |
| | | glycol, 3% | | | | | |
| Comparative 2 | 0.9% | Phenoxy | 0.3% | 0.3% | 0.3% | 0.5% | 3.34/6.30 |
| | | glycol, 3% | | | | | |
| Comparative 3 | 0.9% | Phenethyl | 0.3% | 0.3% | 0.3% | 0.5% | 3.46/6.30 |
| | | alcohol, 3% | | | | | |
| Comparative 4 | 0.9% | 2-Butoxy | 0.3% | 0.3% | 0.3% | 0.5% | 1.73/6.30 |
| | | ethanol, 3% | | | | | |
| Comparative 5 | 0.9% | N/A | 0.3% | 0.3% | 0.3% | 1.0% | 0.64/6.46 |

As shown in Table 7, the disinfectant composition including benzyl alcohol exceeds all other tested alternatives, despite the tested alternatives being generally chemically similar organic solvents to benzyl alcohol. The results show the particular effectiveness of benzyl alcohol disinfectant compositions above comparable compositions. Nonetheless, other organic solvents including benzyl glycol, phenoxy glycol, phenethyl alcohol, and 2-butoxyethanol, likewise, performed better than the baseline Comparative Example 5, which did not include any organic solvent.

Disinfecting compositions having different first surfactants, i.e., different amine oxides, and different pH adjusters were tested and their efficacies compared. Tables 8 and 9 below shows the results of these tests.

TABLE 8
First Surfactants

| | Hydrogen | Benzyl | Octanoic | | Tomadol | Phosphoric | Efficacy Log |
|---|---|---|---|---|---|---|---|
| Sample ID | Peroxide | Alcohol | Acid | Amine Oxide | 900 | Acid | reduction/control |
| Example 1 | 0.9% | 3.0% | 0.3% | Ammonyx ® | 0.3% | 0.5% | >5.60/6.60 |
| | | | | LO, 0.3% | | | |
| | | | | (lauramine | | | |
| | | | | oxide) | | | |
| Example 2 | 0.9% | 3.0% | 0.3% | Barlox 8S, 0.3% | 0.3% | 0.5% | >6.09/7.09 |
| | | | | (octyl dimethyl | | | |
| | | | | amine oxide) | | | |
| Example 3 | 0.9% | 3.0% | 0.3% | Barlox 10S, 0.3% | 0.3% | 0.5% | >6.09/7.09 |
| | | | | (decyl dimethyl | | | |
| | | | | amine oxide) | | | |
| Example 4 | 0.9% | 3.0% | 0.3% | Barlox 12, 0.3% | 0.3% | 0.5% | >6.09/7.09 |
| | | | | (cocoamine | | | |
| | | | | oxide) | | | |
| Example 5 | 0.9% | 3.0% | 0.3% | Barlox 14, 0.3% | 0.3% | 0.5% | >6.09/7.09 |
| | | | | (myristal amine | | | |
| | | | | oxide) | | | |

TABLE 9
Acidic pH Adjusters

| | Hydrogen | Benzyl | Octanoic | Ammonyx ® | Tomadol | pH | | Efficacy Log |
|---|---|---|---|---|---|---|---|---|
| Sample ID | Peroxide | Alcohol | Acid | LO | 900 | Adjuster | pH | reduction/control |
| Example 1 | 0.9% | 3.0% | 0.3% | 0.3% | 0.3% | Phosphoric | 2.26 | >6.09/7.09 |
| | | | | | | acid 0.5% | | |
| Example 2 | 0.9% | 3.0% | 0.3% | 0.3% | 0.3% | Methanesulfonic | 2.15 | >6.09/7.09 |
| | | | | | | acid, 0.2% | | |
| Example 3 | 0.9% | 3.1% | 0.3% | 0.3% | 0.3% | Sulfuric | 2.16 | >6.09/7.09 |
| | | | | | | Acid, 0.5% | | |
| Example 4 | 0.9% | 3.0% | 0.3% | 0.3% | 0.3% | Hydrochloric | 2.20 | >6.09/7.09 |
| | | | | | | Acid, 0.5% | | |

Tables 8 and 9 show that desirable efficacies are maintained for the disinfectant composition with various amine oxides and various acidic pH adjusters. In addition, as shown in Table 9, the pH for the disinfectant composition can be within a range of about 2 to about 3.

Certain relative ratios of the organic alcohol, the fatty acid or aromatic carboxylic acid, and the amphoteric surfactant can lead to different efficacies in disinfectant compositions. Particularly desirable mass ratios of the organic solvent to fatty acid or aromatic carboxylic acid include a mass ratio from 3:1 to 3:0.1, by percent weight of the disinfectant composition. Particularly desirable mass ratios of the organic solvent to the amphoteric surfactant include a mass ratio from 1:1 to 30:1, by percent weight of the disinfectant composition. Particularly desirable mass ratios of the fatty acid or aromatic carboxylic acid to amphoteric surfactant include a mass ratio from 0.1:1 to 3:1, by percent weight of the infectant composition. In addition, the test results illustrate that the length of the carbon chain in the fatty acid can play a role in the efficacy of the disinfectant compositions, with particularly desirable efficacies observed when using fatty acids having chains of from 6 to 9 carbon atoms. Notably, disinfectant compositions having fatty acids with chains longer than 9 carbon atoms showed a sudden, and significant decreases in efficacy while disinfectant compositions having fatty acids with chains shorter than 6 carbon atoms showed similar sudden and significant decreases in efficacy. And efficacy differences exist between disinfectant compositions having similar, but different, organic solvents.

Disinfecting compositions having aromatic carboxylic acids, i.e., different acids than the straight-chained fatty acids tested previously, were tested and their efficacies compared. Table 10 below shows the results of these tests.

TABLE 10
Different Aromatic Acids

| | | | | | | | Efficacy Log |
|---|---|---|---|---|---|---|---|
| | Hydrogen | Benzyl | Organic Acid, | Ammonyx | Tomadol | Phosphoric | reduction/ |
| Sample ID | Peroxide | Alcohol | 0.3% | LO | 900 | Acid | control |
| Example 1 | 0.9% | 3.0% | Salicylic Acid | 0.3% | 0.3% | 0.6% | >6.08/7.08 |
| Example 2 | 0.9% | 3.0% | 2-Furoic Acid | 0.3% | 0.3% | 0.6% | >6.08/7.08 |
| Example 3 | 0.9% | 3.0% | Benzoic Acid | 0.3% | 0.3% | 0.6% | >6.08/7.08 |

Table 10 shows that efficacy of the disinfectant solution remains high even with the substitution of an aromatic carboxylic acid for the fatty acids having C6-C9 straight chains described above.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and method and illustrative examples shown and described. Accordingly, departures may be made from such details without departing from the scope of the general inventive concept.

What is claimed is:

1. A disinfectant composition comprising:
hydrogen peroxide;
an organic solvent in an amount from about 0.9 wt % to 4 wt % of the composition;
one of a fatty acid selected from the group consisting of hexanoic acid, heptanoic acid, octanoic acid, and nonanoic acid, or an aromatic carboxylic acid selected from benzoic acid, salicylic acid, or 2-fuoric acid;
a first surfactant comprising an amine oxide;
a second surfactant comprising an alcohol ethoxylate; and
an acidic pH adjuster,
wherein the organic solvent and the fatty acid or aromatic carboxylic acid are present in a ratio from about 10:1 to about 30:1, the fatty acid or aromatic carboxylic acid and first surfactant are present in a ratio from about 0.1:1 to about 3:1, and the organic solvent and first surfactant are present in a ratio from about 1:1 to about 30:1.

2. The disinfectant composition of claim 1, wherein the hydrogen peroxide is present in the disinfectant composition in an amount from 0.1 wt % to 8 wt % of the disinfectant composition.

3. The disinfectant composition of claim 1, wherein the fatty acid or aromatic carboxylic acid is present in an amount from 0.1 wt % to 1 wt % of the composition.

4. The disinfectant composition of claim 1, wherein the first surfactant is present in an amount from 0.1 wt % to 1 wt % of the composition.

5. The disinfectant composition of claim 1, wherein the fatty acid or aromatic carboxylic acid is present in an amount from 0.1 wt % to 0.4 wt % of the composition, and the first surfactant is present in an amount from 0.1 wt % to 1 wt % of the composition.

6. The disinfectant composition of claim 1, wherein the pH adjuster is selected from the group consisting of phosphoric acid, sulfuric acid, hydrochloric acid, and methanesulfonic acid.

7. The disinfectant composition of claim 1, wherein the pH adjuster is present in an amount from 0.1 wt % to 2 wt % of the disinfectant composition.

8. The disinfectant composition of claim 1, wherein the pH of the disinfectant composition is between 1 to 3.

9. The disinfectant composition of claim 1, wherein the composition includes the fatty acid selected from the group consisting of hexanoic acid, heptanoic acid, octanoic acid, and nonanoic acid.

10. The disinfectant composition of claim 1, wherein the composition includes the aromatic carboxylic acid selected from benzoic acid, salicylic acid, or 2-furoic acid.

11. The disinfectant composition of claim 1, wherein the amine oxide is amphoteric and the alcohol ethoxylate is nonionic.

12. The disinfectant composition of claim 1, wherein the amine oxide is an alkyl amine oxide or an alkyl dimethyl amine oxide.

13. The disinfectant composition of claim 1, wherein the organic solvent is selected from a group consisting of benzyl alcohol, phenethyl alcohol, phenoxy glycol, or combinations thereof.

14. The disinfectant composition of claim 1, wherein the composition does not include any detectable peracids.

15. The disinfectant composition of claim 1, wherein the composition is free from any peracids.

16. A disinfectant wipe comprising a substrate having absorbed or adsorbed thereon the disinfectant composition of claim 1.

17. A disinfectant composition consisting of:
hydrogen peroxide;
benzyl alcohol in an amount from 2 wt % to 4 wt % of the disinfectant composition;
one of a fatty acid selected from the group consisting of hexanoic acid, heptanoic acid, octanoic acid, and nonanoic acid or an aromatic carboxylic acid selected from benzoic acid, 2-furoic acid, or salicylic acid;
an amphoteric surfactant;
a nonionic surfactant;
an acidic pH adjuster; and
water,
wherein the benzyl alcohol and the fatty acid or aromatic carboxylic acid are present in a ratio from about 3:1 to about 30:1, the fatty acid or aromatic carboxylic acid and the amphoteric surfactant are present in a ratio from about 0.1:1 to about 3:1, and the benzyl alcohol and the amphoteric surfactant are present in a ratio from about 1:1 to about 30:1, and wherein the composition is free from any peracids.

18. The disinfectant composition of claim 17, wherein the composition consists of the fatty acid selected from the group consisting of hexanoic acid, heptanoic acid, octanoic acid, and nonanoic acid.

19. The disinfectant composition of claim 17, wherein the composition consists of the aromatic carboxylic acid selected from benzoic acid, 2-furoic acid, or salicylic acid.

20. The disinfectant composition of claim 17, wherein the amphoteric surfactant is an amine oxide and the nonionic surfactant is an ethoxylated alcohol.
